(19) United States
(12) Patent Application Publication
(10) Pub. No.: US 2026/0312024 A1
(43) Pub. Date: Oct. 8, 2026

(54) NICKEL-RICH CATHODE ACTIVE MATERIAL HAVING DOPED-RESTRUCTURED COATING AND ONE-STEP MANUFACTURING METHOD OF THE SAME

(71) Applicants: Samsung SDI Co., Ltd., Yongin-si (KR); The Trustees of the Stevens Institute of Technology, Hoboken, NJ (US)

(72) Inventors: Yuanyuan MA, Cambridge, MA (US); Yong Seok KIM, Cambridge, MA (US); Min Han KIM, Cambridge, MA (US); Soon Rewl LEE, Cambridge, MA (US); Jae Chul KIM, Ridgewood, NJ (US); Danna YAN, Jersey City, NJ (US)

(21) Appl. No.: 19/169,962

(22) Filed: Apr. 3, 2025

(51) Int. Cl. H01M 4/525; H01M 4/02; H01M 4/36

(52) U.S. Cl. CPC H01M 4/525; H01M 4/366; H01M 2004/021

(57) ABSTRACT

A doped, reconstructed cathode active material including an amount of nickel of at least about 85 mol % based on a total weight of the cathode active material, a bulk region, and a reconstructed region is provided. The bulk region has a bulk crystal structure having a bulk space group and a bulk interplanar spacing, and the reconstructed region has a surface crystal structure having a surface space group and a surface interplanar spacing. The bulk space group is different than the surface space group, and the bulk interplanar spacing is greater than the surface interplanar spacing. A method of manufacturing the doped, reconstructed cathode active material and a method of operating a rechargeable lithium battery that includes the doped, reconstructed cathode active material are provided.

### BACKGROUND

### 1. Field

One or more embodiments of the present disclosure relate to a doped, reconstructed nickel-rich cathode active material having a bulk region and a reconstructed region, and a method of preparing the doped, reconstructed nickel-rich cathode active material. One or more embodiments relate to a rechargeable lithium battery including the doped, reconstructed nickel-rich cathode active material and a method of operating the rechargeable lithium battery.

### 2. Description of the Related Art

Electric vehicles and electronic devices such as smart phones, laptops, and/or the like, use a rechargeable lithium battery having high energy density and easy portability as a driving power source. In response to the recent rapid spread of electric vehicles and electronic devices using rechargeable lithium batteries, research to develop a rechargeable lithium battery having enhanced performance characteristics (e.g., high capacity and high energy density) has been actively conducted.

Cathode active materials utilized to provide rechargeable lithium batteries having enhanced performance characteristics include Ni-rich layered oxides having at least 80% nickel (Ni). However, incorporating more than 80% Ni into large, high capacity, high voltage, and/or high energy density rechargeable lithium batteries has been challenging due to the physicochemical properties of Ni which cause the bulk-phase and surface stability of these materials to be weak, for example, when operated at relatively high voltage. For example, oxidized Ni may destabilize upon delithiation to create a delithiated layered Ni-rich lithium transition metal oxide (LiTMO₂) phase that undergoes an irreversible phase transformation that leads to subsequent capacity decay. This phase transformation is largely associated with oxygen loss at high state of charge resulting in spontaneous Ni reduction, especially at the particle surface. Thus, particle passivation (e.g., coating) that can suppress or reduce the oxygen loss has been considered an effective approach to extending the cycle life of Ni-rich LiTMO₂ cathodes.

In a chemically homogeneous particle, phase separation can be engineered by doping foreign elements or suitably varying transition metal compositions. For example, doping of heavy metal elements (e.g., Zr and W) into Ni-rich LiTMO₂ particles leads to the formation of electrochemically inert rocksalt-like phases on the particle surface, while maintaining the layered phase in the bulk of the particle. The surface rocksalt phases have Zr (or W)-rich compositions and are formed with self-limiting thickness upon electrochemical cycling. However, details of the mechanisms by which rocksalt phases not having fast Li diffusion pathways offer reversible Li intercalation across the surface and interphases over an extended number of cycles remain unclear.

Oxygen evolution can induce different types (or kinds) of surface phase transformations. For example, in 20 mol % Li-excess disordered-rocksalt cathodes that have certain transition metal compositions (e.g., Nb and Mn), spinel-like surface phases, rather than the rocksalt, can form during the first few charge and discharge cycles thereby promoting long-term capacity stability. Spinel phases exhibit excellent Li transport kinetics and can be considered desirable to passivate layered cathode particles, but the underlying mechanisms to control surface phase transformation reactions remain unclear. Not wishing to be limited by theory, engineering spontaneous phase separation may provide functional particle structures to extend the cycle life of Ni-rich LiTMO₂ cathodes, but it is unclear as to how to obtain such structures.

Accordingly, there is a desire to improve the stability of the cathode active material for use in a high capacity or a high energy density rechargeable lithium battery, particularly for high voltage operating conditions.

The above information disclosed in this Background section is only for enhancement of understanding of the background of the present disclosure and therefore the information discussed in this Background section does not necessarily constitute prior art.

### SUMMARY

One or more embodiments of the present disclosure provide the results of investigations of shifting the energetics of particle construction and reconstruction to manufacture a longer-lasting Ni-rich cathode active material. Presented herein are the effects of stoichiometry and particle size distribution of a precursor mixture on the physicochemical properties of the Ni-rich cathode active material during synthesis and electrochemical cycling. In one or more embodiments, the precursor and doping ratios are related to thermodynamic and kinetic coordinates of phase transformation reactions and selection of these parameters may impact crystallite size, composition gradient, and surface morphology to provide Ni-rich cathode active materials having highly reversible Li cycling performance.

One or more embodiments of the present disclosure provides for a method of forming electrochemically-stable and kinetically-suitable surface phases for Ni-rich cathode active materials in a single firing step by selecting compositions and particle size distributions. In one or more embodiments, the method provides a one-step (e.g., single pot) method of manufacturing Ni-rich cathode active materials. The methods described herein do not require a separate or extra process step of applying a coating and form conformal and cohesive surface phases for the Ni-rich cathode active materials.

One or more aspects of embodiments of the present disclosure are directed toward a cathode active material including an amount of nickel of at least about 85 mol % based on a total weight of the cathode active material. The cathode active material includes a bulk region and a reconstructed region, and may be referred to as a doped, reconstructed nickel-rich cathode active material. The bulk region has a bulk crystal structure having a bulk space group and a bulk interplanar spacing. The reconstructed region has a surface crystal structure that includes a surface space group and a surface interplanar spacing. An outer surface of the reconstructed region may be the outer surface of the doped, reconstructed nickel-rich cathode active material. The bulk space group is different than the surface space group and the bulk interplanar spacing is greater than the surface interplanar spacing.

In one or more embodiments, the bulk crystal structure may have a layered structure, and the bulk interplanar spacing may be about 0.45 nanometer (nm) to about 0.50 nm.

In one or more embodiments, the bulk space group may be a rhombohedral space group having a (003) plane and a (101) plane adjacent to the (003) plane.

In one or more embodiments, the surface interplanar spacing may be about 0.20 nm to about 0.30 nm.

In one or more embodiments, the surface space group may be a face centered cubic space group having a (111) plane.

In one or more embodiments, the bulk interplanar spacing may be about 1.8 to about 2.2 times greater than the surface interplanar spacing.

In one or more embodiments, the bulk crystal structure may have a [1, 0, 0] projection. In one or more embodiments, the bulk crystal structure may have a layered symmetry.

In one or more embodiments, the surface crystal structure may have a [1, 2, −1] projection. In one or more embodiments, the surface crystal structure may have a cubic symmetry.

In one or more embodiments, the cathode active material may include a group 4 element, a group 6 element, a group 13 element, and at least one element selected from among groups 8 to 10, as selected from the Periodic Table of Elements.

In one or more embodiments, the cathode active material may include a bulk composition represented by Chemical Formula 1 and a doping composition represented by Chemical Formula 2:

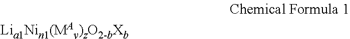

wherein, each M^{A} may independently be selected from among Al, B, Ba, Ca, Ce, Co, Cr, Cu, Fe, Mg, Mn, Mo, Nb, Si, Sn, Sr, Ti, V, W, and Zr; each X may independently be selected from among F, P, and S; 0.9≤a1≤1.2; 0.8≤n1≤0.995; each y may independently be a real number from 0 to 0.2; z may be an integer from 1 to 5, and 0≤b≤0.1.

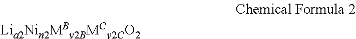

wherein, M^{B} may be a transition metal selected from a group 4 element; M^{C} may be a transition metal selected from a group 6 element; 0.9≤a2≤1.5; n2 and y2B may each independently be a real number from 0.27 to 0.39; and a sum of n2+y2B+y2C may be equal to 2−a2.

In one or more embodiments, the bulk composition may be represented by Chemical Formula 1A and the doping composition may be represented by Chemical Formula 2A:

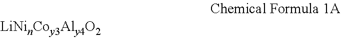

wherein, 0.9≤n≤0.995; 0.005≤y3≤0.1; and a sum of n+y3+y4 may be equal to 1,

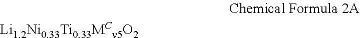

wherein, M^{C} is Mo or W; and 0.10≤y5≤0.16.

In one or more embodiments, the reconstructed region is at a surface of the cathode active material and comprises a group 4 element and a group 6 element.

In one or more embodiments, the reconstructed region further comprises a group 13 element and at least one element selected from among groups 8 to 10.

In one or more embodiments, the a thickness of the reconstructed region is about 2% to about 20% of a size of primary particles of the cathode active material.

In one or more embodiments, the cathode active material may include secondary particles, each secondary particle including an agglomeration of primary particles. The secondary particles may have an average particle diameter (D50) of about 10 micrometer (μm) to about 18 μm. The primary particles may have an average particle diameter (D50) of about 15 nanometer (nm) to about 300 nm.

One or more aspects of embodiments of the present disclosure are directed toward a method of manufacturing a doped, reconstructed nickel-rich cathode active material. The method includes providing a bulk composition, providing a doping composition (e.g., a doping reconstruction composition), mixing the bulk composition and the doping composition to provide an intermediate, and heat treating the intermediate in an oxidative atmosphere. In one or more embodiments, the method includes a single heat treating step (e.g., act or task). In one or more embodiments, the method may be a one-step (e.g., single pot) method of manufacturing the doped, reconstructed nickel-rich cathode active material.

In one or more embodiments, the providing of the intermediate includes mixing the bulk composition and the doping composition in a weight ratio that may be about 1:0.5 to about 1:0.001.

In one or more embodiments, the providing of the bulk composition may include mixing an amount of a first Li compound, an amount of an Al salt, and a first solvent to form a first precursor; providing to the first precursor an added portion of the first Li compound and an amount of a Ni composite oxide to form a first composite, the nickel composite oxide being represented by Chemical Formula 3:

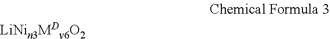

wherein, M^{D} may be Co or Fe; 0.9≤n3≤0.995; and a sum of n3+y6 may be equal to 1; and heat treating the first composite.

In one or more embodiments, the providing of the doping composition may include mixing an amount of a second Li compound, an amount of an Ni oxide, an amount of a group 4 oxide, an amount of a group 6 oxide, and a second solvent to form a second precursor; processing the second precursor; and heat treating the second precursor.

In one or more embodiments of the method, the group 4 oxide may be TiO₂ and the group 6 oxide may be MoO₂ or WO₃.

One or more aspects of embodiments of the present disclosure are directed toward a method of operating a battery. For example, the battery may include a positive electrode that includes the doped, reconstructed nickel-rich cathode active material described herein; a negative electrode; and an electrolyte between the positive electrode and the negative electrode. In one or more embodiments, a capacity retention of the battery may be at least about 85% if (e.g., when) an operating voltage is at least about 3.9 volt (V).

Additional aspects of embodiments will be set forth in part in the description which follows and, in part, will be apparent from the description, or may be learned by practice of the presented embodiments of the disclosure.

The cathode active material according to one or more embodiments may be a doped, reconstructed nickel-rich cathode active material having high charge capacity and energy density. The doped, reconstructed nickel-rich cathode active material may have improved stability when included in a rechargeable lithium battery operated at high voltage conditions.

### BRIEF DESCRIPTION OF THE DRAWINGS

The patent or application file contains at least one drawing executed in color. Copies of this patent or patent application publication with color drawings will be provided by the Office upon request and payment of the necessary fee.

The preceding and other objects and features of embodiments of the present disclosure will become more apparent to those of ordinary skill in the art by describing example embodiments thereof in more detail with reference to the accompanying drawings. In the drawings:

FIG. 1 shows a doped, reconstructed nickel-rich cathode active material according to one or more embodiments.

FIG. 2A shows X-ray powder diffraction (XRD) patterns of a nickel-rich cathode active material and doped, reconstructed nickel-rich cathode active materials according to one or more embodiments.

FIGS. 2B-2D show peak splitting sections of the XRD patterns of FIG. 2A.

FIG. 3A shows scanning electron microscopy (SEM) and energy-dispersive X-ray spectroscopy (EDS) images of a nickel-rich cathode active material according to one or more embodiments.

FIGS. 3B and 3C show SEM and EDS images of doped, reconstructed nickel-rich cathode active materials according to one or more embodiments.

FIG. 4A shows a cross-sectional SEM image of a particle of a nickel-rich cathode active material according to one or more embodiments.

FIG. 4B shows EDS intensities of the nickel-rich cathode active material of FIG. 3A.

FIGS. 5A and 6A show cross-sectional SEM images of particles of doped, reconstructed nickel-rich cathode active materials according to one or more embodiments.

FIGS. 5B and 6B show EDS intensities of the doped, reconstructed nickel-rich cathode active materials of FIGS. 5A and 6A.

FIGS. 7A and 8A show cross-sectional SEM images of surfaces of particles of doped, reconstructed nickel-rich cathode active materials according to one or more embodiments.

FIGS. 7B and 8B show EDS intensities of the particles of the doped, reconstructed nickel-rich cathode active materials of FIGS. 7A and 8A.

FIGS. 9A-9F are high resolution transmission electron microscopy (TEM) images of a doped, reconstructed nickel-rich cathode active material according to one or more embodiments.

FIGS. 10A-10F are high resolution TEM images of a doped, reconstructed nickel-rich cathode active material according to one or more embodiments.

FIGS. 11A-11D show electrochemical performance of coin cells including a nickel-rich cathode active material and doped, reconstructed nickel-rich cathode active materials according to one or more embodiments.

FIG. 12 is a cutaway perspective view schematically showing a rechargeable lithium battery according to one or more embodiments.

FIG. 13 is a cross-sectional view schematically showing a rechargeable lithium battery according to one or more embodiments.

FIGS. 14 and 15 are perspective views schematically showing a rechargeable lithium battery according to one or more embodiments.

### DETAILED DESCRIPTION

In order to sufficiently understand the configuration and effect of embodiments of the present disclosure, example embodiments of the present disclosure will be described in more detail with reference to the accompanying drawings. However, it should be noted that this is provided by way of example, and the present disclosure is not limited thereby and is only defined by the scope of the appended claims, and equivalents thereof, described in more detail herein. Rather, the example embodiments are provided only to disclose the subject matter of the present disclosure and let those skilled in the art fully know the scope of the present disclosure.

In the drawings, the thickness of layers, films, regions, and/or the like, may be exaggerated for clarity and like reference numerals designate like elements throughout, and duplicative descriptions thereof may not be provided in the specification. Unless stated otherwise in the specification, if a portion of a layer, film, region, and/or the like is referred to as being “on” another portion, this includes not only the case in which the portion is “directly on” another portion but also the case in which there is another portion interposed therebetween.

Unless stated otherwise in the specification, singular expressions may include plural expressions. Also, unless stated otherwise, “A or B” may refer to “including A, including B, or including A and B.”

In the specification, a “combination thereof” may refer to a mixture, composite, composition, copolymer, alloy, blend, and/or reaction product of constituents.

The terms “comprises,” comprising,” “comprise,” “including,” “includes,” “include,” “having,” “has,” and “have,” as used in this description, are intended to designate the presence of an embodied aspect, number, act, task, element, and/or a (e.g., any suitable) combination thereof. However, the use of these terms does not preclude or exclude the possibility of the presence or addition of one or more other components, features, aspects, numbers, acts, tasks, elements, and/or a (e.g., any suitable) combination thereof.

In one or more embodiments, the term “layer” as used herein includes not only a shape formed or provided on the whole surface if viewed from a plan view, but also a shape formed or provided on a partial surface.

It will be understood that, although the terms “first,” “second,” “third,” and/or the like may be utilized herein to describe one or more suitable elements, components, regions, layers and/or sections, these elements, components, regions, layers and/or sections should not be limited by these terms. These terms are only utilized to distinguish one element, component, region, layer or section from another element, component, region, layer, or section. Thus, a first element, component, region, layer, or section described herein may be termed a second element, component, region, layer or section without departing from the spirit and scope of the present disclosure.

As utilized herein, the term “and/or” includes any, and all, combinations of one or more of the associated listed items. Expressions such as “at least one of,” “one of,” “selected from among,” and “selected from,” if preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

Spatially relative terms, such as “beneath,” “below,” “lower,” “above,” “upper,” and/or the like, may be utilized herein to easily describe the relationship between one element or feature and another element or feature. It will be understood that the spatially relative terms are intended to encompass different orientations of a device in utilization or operation in addition to the orientation illustrated in the drawings. For example, if the device in the drawings is turned over, elements described as “below” or “beneath” other elements or features will be oriented “above” the other elements or features. Thus, the example term “below” can encompass both (e.g., simultaneously) the orientations of above and below. The device may be otherwise oriented (rotated 90 degrees or at other orientations), and the spatially relative terms utilized herein may be interpreted accordingly.

Unless otherwise defined, all terms (including chemical, technical and scientific terms) utilized herein have the same meaning as commonly understood by one of ordinary skill in the art to which this disclosure pertains. It will be further understood that terms, such as those defined in commonly utilized dictionaries, should be interpreted as having a meaning that is consistent with their meaning in the context of the related art and the present disclosure, and will not be interpreted in an idealized or overly formal sense.

Example embodiments may be described herein with reference to cross-sectional views, which are schematic views of idealized embodiments. As such, variations from the shapes of the illustrations as a result, for example, of manufacturing techniques and/or tolerances, are to be expected. Thus, embodiments described herein should not be construed as being limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the drawings are schematic in nature and their shapes are not intended to illustrate the precise shape of a region and are not intended to limit the scope of the appended claims.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item. Descriptions of features or aspects within each embodiment should typically be considered as available for other similar features or aspects in other embodiments.

In this context, “consisting essentially of” indicates that any additional components will not materially affect the chemical, physical, optical and/or electrical properties of the semiconductor film.

Further, in this specification, the phrase “plan view,” indicates viewing a target portion from the top, and the phrase “on a cross-section” indicates viewing a cross-section formed by vertically cutting a target portion from the side.

In the context of the present application and unless otherwise defined, the terms “use,” “using,” and “used” may be considered synonymous with the terms “utilize,” “utilizing,” and “utilized,” respectively.

The term “particle diameter” as utilized herein refers to an average diameter of particles if the particles are spherical, and refers to an average major axis length of particles if the particles are non-spherical. For example, the average particle diameter may be measured by any suitable method in the art, for example, by a particle size analyzer, and/or by a transmission electron microscopic image and/or a scanning electron microscopic image. A value for the average particle diameter may be obtained by dynamic light scattering analysis methodology, performing data analysis, counting the number of particles for each particle size range, and calculating the data obtained. Unless otherwise defined, the average particle diameter may refer to the diameter (D₅₀) of particles having a cumulative volume of 50 volume % in the particle size distribution. If measuring by laser diffraction, for example, the particles to be measured are dispersed in a dispersion medium and then introduced into a related art laser diffraction particle size measuring device (e.g., MT 3000 available from Microtrac, Ltd.) utilizing ultrasonic waves at about 28 kHz, and after irradiation with an output of 60 W, the average particle diameter (D50) based on 50% of the particle size distribution in the measuring device may be calculated. As utilized herein, if (e.g., when) a definition is not otherwise provided, the average particle diameter refers to a diameter (D₅₀) of particles having a cumulative volume of 50 volume % in the particle size distribution that is obtained by measuring the size (diameter or major axis length) of about 20 particles at random in a scanning electron microscopic image.

The following description includes non-limiting examples of values for quantities that are a part of the present disclosure. The example values are described as example ranges for the quantities and it will be understood that any and all of the following example ranges may include any sub-range beginning and/or ending with any value thereof. An example range of “about 60% to about 80%” may also include, for example, about 60.0% to about 75%, about 68% to about 80.0%, about 68% to about 72%, about 69.5% to about 70.5%, about 70.0%, and about 70%.

### Doped, Reconstructed Nickel-Rich Cathode Active Material

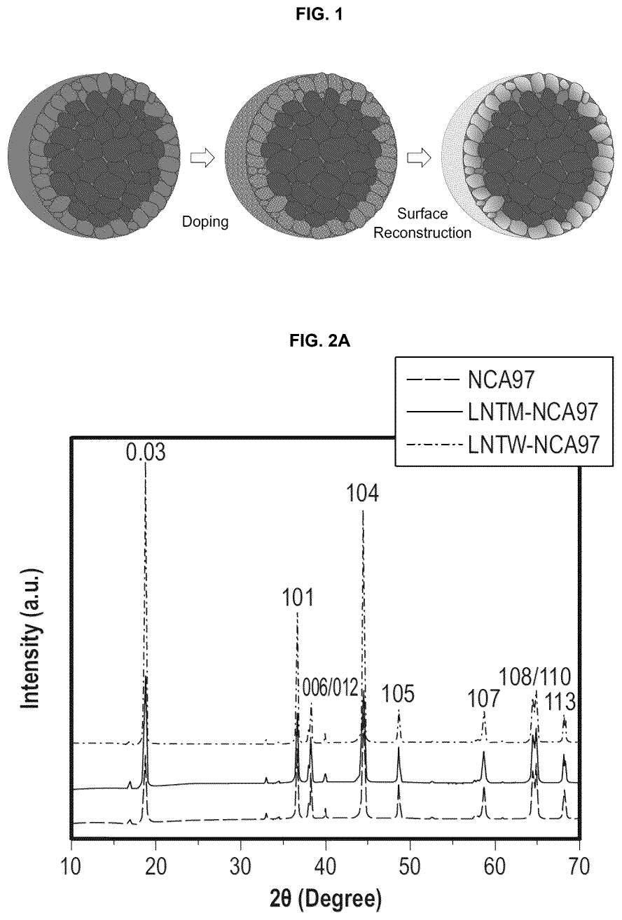

A cathode active material according to one or more embodiments of the present disclosure includes a bulk region and a reconstructed region, and may be referred to as a doped, reconstructed nickel-rich cathode active material. FIG. 1 at right shows a doped, reconstructed nickel-rich cathode active material of one or more embodiments with the bulk region darkly shaded and the reconstructed region faintly shaded. FIG. 1 provides an overview of a method of manufacturing the doped, reconstructed nickel-rich cathode active material as described in more detail elsewhere herein. In one or more embodiments, the doped, reconstructed nickel-rich cathode active material may be a layered lithium transition metal oxide and the reconstructed region provides a protective layer that reduces or suppresses the loss of oxygen from the nickel-rich, bulk region of the cathode active material.

The cathode active material includes an amount of nickel of at least about 85 mol % based on a total weight of the cathode active material. For example, the amount of nickel in the cathode active material may be about 85 wt % to about 99.5 wt %, about 85 wt % to about 99 wt %, about 85 wt % to about 98 wt %, about 85 wt % to about 95 wt %, about 90 wt % to about 95 wt %, or about 92 wt % to about 95 wt %, based on a total weight of the cathode active material.

The bulk region has a bulk crystal structure having a bulk space group and a bulk interplanar spacing.

In one or more embodiments, the bulk space group may be a rhombohedral space group having a (003) plane and a (101) plane adjacent to the (003) plane. For example, the bulk space group may be a R-3m space group.

In one or more embodiments, the bulk crystal structure may have a [1, 0, 0] projection. In one or more embodiments, the bulk crystal structure may have a layered symmetry.

In one or more embodiments, the bulk crystal structure may have a layered structure, and the bulk interplanar spacing may be about 0.45 nanometer (nm) to about 0.50 nm. For example, the bulk interplanar spacing may be about 0.455 nm to about 0.495 nm, about 0.46 nm to about 0.49 nm, or may be about 0.455 nm, 0.46 nm, 0.465 nm, 0.47 nm, 0.475 nm, 0.48 nm, 0.485 nm, 0.49 nm, or 0.495 nm.

The reconstructed region has a surface crystal structure having a surface space group and a surface interplanar spacing. In one or more embodiments, the reconstructed region may be on an external surface of cathode active material, or near an external surface of cathode active material. In one or more embodiments, the surface crystal structure may be on the external surface of cathode active material, or near the external surface of cathode active material. The bulk space group may be different than the surface space group and the bulk interplanar spacing may be greater than the surface interplanar spacing.

In one or more embodiments, the surface space group may be a face centered cubic space group having a (111) plane. For example, the surface space group may be a Fm-3m space group.

In one or more embodiments, the surface crystal structure may have a [1, 2, −1] projection. In one or more embodiments, the surface crystal structure may have a cubic symmetry.

In one or more embodiments, the surface interplanar spacing may be about 0.20 nm to about 0.30 nm. For example, the surface interplanar spacing may be about 0.21 nm to about 0.29 nm, about 0.23 nm to about 0.27 nm, or may be about 0.22 nm, 0.225 nm, 0.23 nm, 0.235 nm, 0.24 nm, 0.245 nm, 0.25 nm, 0.255 nm, or 0.265 nm.

In one or more embodiments, the bulk interplanar spacing may be about 1.8 to about 2.2 times greater than the surface interplanar spacing. For example, the bulk interplanar spacing may be about 1.85 to about 2.15, about 1.95 to about 2.1, or may be about 1.85, 1.9, 1.95, 2, 2.05, 2.1, 2.15, or 2.2 times greater than the surface interplanar spacing.

In one or more embodiments, the cathode active material as a whole may have an overall crystal structure having a rhombohedral structure, as determined by X-ray powder diffraction (XRD). For example, the overall the crystal structure may have a R-3m space group and an α-NaFeO₂ hexagonal structure. In one or more embodiments, the overall crystal structure may have a ratio of (003)/(104) peak intensity of about 1.12 to about 1.30. For example, the ratio of (003)/(104) peak intensity may be about 1.12 to about 1.30, about 1.14 to about 1.28, about 1.16 to about 1.26, or may be about 1.12, 1.13, 1.14, 1.15, 1.16, 1.17, 1.18, 1.19, 1.20, 1.21, 1.22, 1.23, 1.24, 1.25, 1.26, 1.27, 1.28, 1.29, or 1.30. In one or more embodiments, the overall the crystal structure may have a (018)/(110) plane peak splitting and a (006)/(012) plane peak splitting.

In one or more embodiments, the bulk space group, the bulk interplanar spacing, the surface space group, and the surface interplanar spacing may be determined by transmission electron microscopy (TEM).

In one or more embodiments, the projections of the bulk crystal structure and the surface crystal structure may be determined by selected area electron diffraction high resolution transmission electron microscopy (SAED-TEM))

In one or more embodiments, the cathode active material may include at least three different elements selected from among different groups of the Periodic Table of Elements. For example, the cathode active material may include a group 4 element, a group 6 element, a group 13 element, and at least one element selected from among groups 8 to 10, as selected from the Periodic Table of Elements. In one or more embodiments, the cathode active material may further include lithium.

In one or more embodiments, the cathode active material may include a bulk composition represented by Chemical Formula 1 and a doping composition represented by Chemical Formula 2:

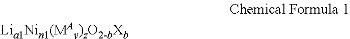

wherein, each M^{A} may independently be selected from among Al, B, Ba, Ca, Ce, Co, Cr, Cu, Fe, Mg, Mn, Mo, Nb, Si, Sn, Sr, Ti, V, W, and Zr; each X may independently be selected from among F, P, and S; 0.9≤a1≤1.2; 0.8≤n1≤0.995; each y may independently be a real number from 0 to 0.2; z may be an integer from 1 to 5, and 0≤b≤0.1.

In one or more embodiments, the bulk composition may be represented by LiNi_{0.97}Co_{0.02}Al_{0.01}O₂ (e.g., NCA97).

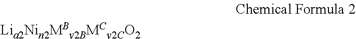

wherein, M^{B} may be a transition metal selected from a group 4 element; M^{C} may be a transition metal selected from a group 6 element; 0.9≤a2≤1.5; n2 and y2B may each independently be a real number from 0.27 to 0.39; and a sum of n2+y2B+y2C may be equal to 2−a2.

In one or more embodiments, the bulk composition may be represented by Chemical Formula 1A and the doping composition may be represented by Chemical Formula 2A:

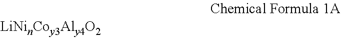

wherein, 0.9≤n≤0.995; 0.005≤y3≤0.1; and a sum of n+y3+y4 may be equal to 1,

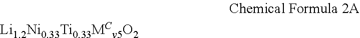

wherein, M^{C} is Mo or W; and 0.10≤y5≤0.16.

In one or more embodiments, the doping composition may be represented by Li_{1.2}Ni_{0.33}Ti_{0.33}Mo_{0.13}O₂ (e.g., LNTM) or Li_{1.2}Ni_{0.33}Ti_{0.33}W_{0.13}O₂ (e.g., LNTW).

In one or more embodiments, the reconstructed region may be at a surface of the cathode active material and may include a group 4 element and a group 6 element.

In one or more embodiments, the reconstructed region may further include a group 13 element and at least one element selected from among groups 8 to 10.

In one or more embodiments, a thickness of the reconstructed region may be about 2% to about 20% of a size of primary particles of the cathode active material. For example, the thickness of the reconstructed region may be is about 3% to about 18%, about 5% to about 15%, or about 8% to about 12% of the size of primary particles of the cathode active material.

In one or more embodiments, the cathode active material may include secondary particles, each secondary particle including an agglomeration of primary particles. The secondary particles may have an average particle diameter (D50) of about 10 micrometer (μm) to about 18 μm. For example, the secondary particles may have an average particle diameter (D50) of about 9 μm to about 16 μm, about 7 μm to about 15 μm, or about 4 μm to about 10 μm. The primary particles may have an average particle diameter (D50) of about 15 nanometer (nm) to about 300 nm. For example, the primary particles may have an average particle diameter (D50) of about 30 nm to about 250 nm, about 50 nm to about 200 nm, or about 80 nm to about 140 nm.

In one or more embodiments, the shape of the secondary particles and the primary particles may each independently be selected from among irregular, spherical, semi-spherical, and elliptical.

A volumetric expansion ratio of the cathode active material according to one or more embodiments may be, at most, about 1% to about 15%. Herein, “volumetric expansion ratio” is a volume of the discharged cathode active material divided by a volume of the charged cathode active material, “discharged” refers to a state of at least 85%, at least 90%, at least 95%, or 100% discharge, and “charged” refers to a state of at least 85%, at least 90%, at least 95%, or 100% charged. For example, the volumetric expansion ratio of the cathode active material may be about 1% to about 15%, about 2% to about 10%, about 3% to about 8%. In one or more embodiments, a volumetric expansion ratio of each of the core, the shell, the coating, the nickel composite oxide, and the piezoelectric composition may be, at most, about 1% to about 15%, (e.g., about 1% to about 15%, about 2% to about 10%, about 3% to about 8%).

The doped, reconstructed nickel-rich cathode active material of the present disclosure may be a layered lithium transition metal oxide having a high charge capacity greater than about 180 milliampere hour per gram (mAh/g) at a charged state of at least about 3.9 volt (V) and is a suitable cathode active material for use in a high energy density battery. In one or more embodiments, the reconstructed region of the doped, reconstructed nickel-rich cathode active material extends the cycle life of a Li-ion battery, e.g., a battery operating at a high state of charge.

In one or more embodiments, the reconstructed region prevents or suppresses the release (e.g., loss) of lattice oxygen from the bulk region of the cathode active material (e.g., during charging/discharging and/or delithiation/lithiation processes of a rechargeable battery).

In one or more embodiments, the reconstructed region may surround and protect the bulk region of the cathode active material from structural deterioration and/or degradation which occur predominately at the surface of the cathode active material.

Use of the cathode active material having the reconstructed region of the present disclosure in a high voltage battery may improve stability and cycle-life characteristics while maximizing or increasing charge capacity and energy density.

### Method of Manufacturing a Doped, Reconstructed Nickel-Rich Cathode Active Material

One or more aspects of embodiments of the present disclosure are directed toward methods of manufacturing a doped, reconstructed nickel-rich cathode active material. The methods include the act or task of providing a bulk composition that may include mixing an amount of a first Li compound, an amount of an Al salt, and a first solvent to form a first precursor. For example, the mixing may include utilizing a blade mixer and at a temperature of about 60° C. to about 110° C. The term “amount,” as related to the methods of manufacturing described herein may be or include a “stoichiometric amount” or “excess amount.” For example, the excess amount be at most about a 0.5 mol % excess, about a 1 mol % excess, about a 2 mol % excess, about a 3 mol % excess, about a 4 mol % excess, about a 5 mol % excess, about a 6 mol % excess, about a 7 mol % excess, about an 8 mol % excess, about a 9 mol % excess, or about a 10 mol % excess, and may include any sub-range beginning and/or ending with any value thereof. As an example, merely for the purpose of illustration and not to limit the present disclosure, the amount of the first Li compound may be about a 6 mol % excess, and the amount of the Al salt may be about a 5 mol % excess,

In one or more embodiments, the first Li compound may be LiOH and/or Li₂CO₃. In one or more embodiments, the first Li compound may be LiOH.

In one or more embodiments, the Al salt may be an Al salt hydrate.

In one or more embodiments, the first solvent may be water or a non-aqueous organic solvent. In one or more embodiments, the first solvent may be water.

The methods include the act or task of providing to the first precursor an added portion of the first Li compound and an amount of a Ni composite oxide to form a first composite. For example, the nickel composite oxide may be provided at a temperature of about 100° C. to about 160° C., and for a period of about 0.25 h to about 24 h.

In one or more embodiments, the nickel composite oxide may be represented by Chemical Formula 3:

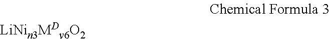

wherein, M^{D} may be Co or Fe; 0.9≤n3≤0.995; and a sum of n3+y6 may be equal to 1. In one or more embodiments, the nickel composite oxide may be LiNi_{0.98}Co_{0.02}O₂.

The methods include the act or task of heat treating the first composite in an oxidative atmosphere (e.g., flowing oxygen atmosphere) to provide the bulk composition. For example, the heat treating may include a temperature of about 300° C. to about 2000° C., and for a period of about 0.25 h to about 72 h.

The methods include the act or task of providing a doping composition (e.g., a doping reconstruction composition), that may include mixing an amount of a second Li compound, an amount of an Ni oxide, an amount of a group 4 oxide, an amount of a group 6 oxide, and a second solvent to form a second precursor. For example, the mixing may include utilizing a blade mixer and at a temperature of about 60° C. to about 110° C.

In one or more embodiments, the second Li compound may be LiOH and/or Li₂CO₃. In one or more embodiments, the second Li compound may be Li₂CO₃.

In one or more embodiments, the group 4 oxide may be TiO₂ and the group 6 oxide may be MoO₂ or WO₃.

In one or more embodiments, the second solvent may be water or a non-aqueous organic solvent. In one or more embodiments, the second solvent may be acetone.

The methods include the acts of tasks of processing the second precursor and heat treating the second precursor (e.g., flowing oxygen atmosphere) to provide the doping composition. The processing the second precursor may include ball-milling in the presence of zirconia grinding media and for a period of about 0.25 h to about 72 h. For example, the heat treating may include a temperature of about 300° C. to about 2000° C., and for a period of 0.25 h to about 72 h.

The methods include the act or task of mixing the bulk composition and the doping composition to provide an intermediate. The methods include the act or task of heat treating the intermediate in an oxidative atmosphere (e.g., flowing oxygen atmosphere). For example, the heat treating may include a temperature of about 300° C. to about 2000° C., and for a period of 0.25 h to about 72 h.

In one or more embodiments, the method includes a single heat treating step (e.g., act or task) of the intermediate.

In one or more embodiments, the act or task of providing of the intermediate includes mixing the bulk composition and the doping composition in a weight ratio that may be about 1:0.5 to about 1:0.001. For example, the weight ratio may be about 1:0.5 to about 1:0.005, about 1:0.5 to about 1:0.01, or about 1:0.5 to about 1:0.02.

In one or more embodiments, the first precursor, the first composite, the first precursor, and/or the intermediate may independently be subjected to a grinding process (e.g., through ball milling) and/or be evaporated (e.g., to dryness).

In one or more embodiments, the method may be a one-step (e.g., single pot) method of manufacturing the doped, reconstructed nickel-rich cathode active material.

### Cathode

In one or more embodiments, a cathode includes a cathode current collector and a cathode active material layer on the cathode current collector, wherein the cathode active material layer includes the preceding cathode active material as described herein. The cathode active material layer may be arranged on at least one surface (e.g., on one or two opposing surfaces) of the cathode current collector. The cathode active material layer may further include other kinds of cathode active materials in addition to the preceding cathode active material as described herein. In embodiments, the cathode active material layer may optionally further include a binder, a conductive material (e.g., an electrically conductive material), and/or a (e.g., any suitable) combination thereof.

According to one or more embodiments, a loading level of the cathode active material layer may be about 10 milligram per square centimeter (mg/cm²) to about 40 mg/cm², for example, about 10 mg/cm² to about 30 about mg/cm², or about 10 mg/cm² to about 20 mg/cm². In embodiments, a density of the cathode active material layer in the final compressed cathode may be about 3.3 gram per cubic centimeter (g/cc) to about 3.7 g/cc, for example, about 3.3 g/cc to about 3.6 g/cc or about 3.4 g/cc to about 3.58 g/cc. If applying the cathode active material according to one or more embodiments, a cathode that satisfies the loading level and cathode density in the described range is suitable for implementing a high-capacity, high-energy-density rechargeable lithium battery.

### Cathode Current Collector

The cathode current collector may be formed in the form of a plate, a foil, and/or the like including (e.g., consisting of), for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and/or an alloy thereof. A thickness of the cathode current collector may be in a range of, for example, about 1 micrometer (μm) to about 100 μm, about 1 μm to about 50 μm, about 5 μm to about 25 μm, or about 10 μm to about 20 μm.

### Binder

The binder improves binding properties of cathode active material particles with one another and with a current collector. Examples of binders may include polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but are not limited thereto.

### Conductive Material

The conductive material is included to provide electrical conductivity and any suitable electrically conductive material may be used as a conductive material unless it causes an undesirable chemical change in the rechargeable lithium battery. Examples of the conductive material may include a carbon-based material such as natural graphite, artificial graphite, carbon black, acetylene black, ketjen black, a carbon fiber, a carbon nanofiber, a carbon nanotube, and/or the like; a metal-based material of a metal powder and/or a metal fiber including copper, nickel, aluminum, silver, and/or the like; an electrically conductive polymer such as a polyphenylene derivative; and/or a (e.g., any suitable) mixture thereof.

Each content (e.g., amount) of the binder and the conductive material may be about 0.5 wt % to about 5 wt % based on 100 wt % of the cathode active material layer.

### Rechargeable Lithium Battery

Some embodiments of the present disclosure provide a battery that includes the preceding cathode as described herein, an anode, and an electrolyte between the cathode and the anode. As an example, the battery may be a rechargeable lithium battery may include a positive electrode (cathode), a negative electrode (anode), a separator between the positive electrode (cathode) and the negative electrode (anode), and an electrolyte. The electrolyte of the rechargeable lithium battery may include an electrolyte solution as described elsewhere herein. In some embodiments, the rechargeable lithium battery may be a solid-state (e.g., all-solid) rechargeable lithium battery. The battery according to one or more embodiments of the present disclosure may be applied in vehicles, electric vehicles, mobile phones, suitable electrical devices, and/or the like but the present disclosure is not limited thereto.

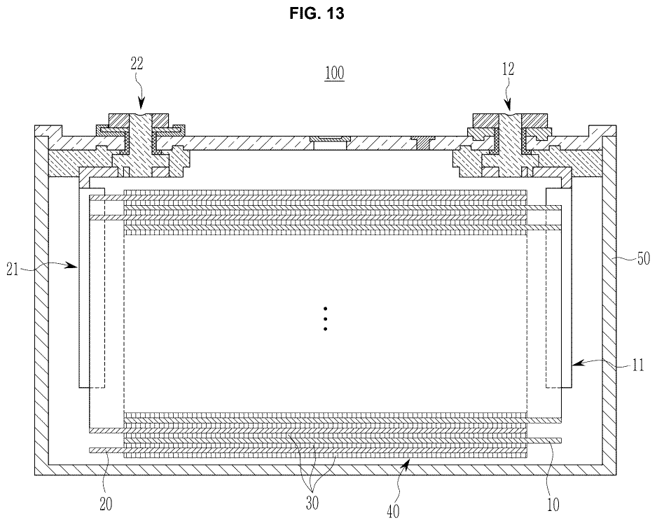

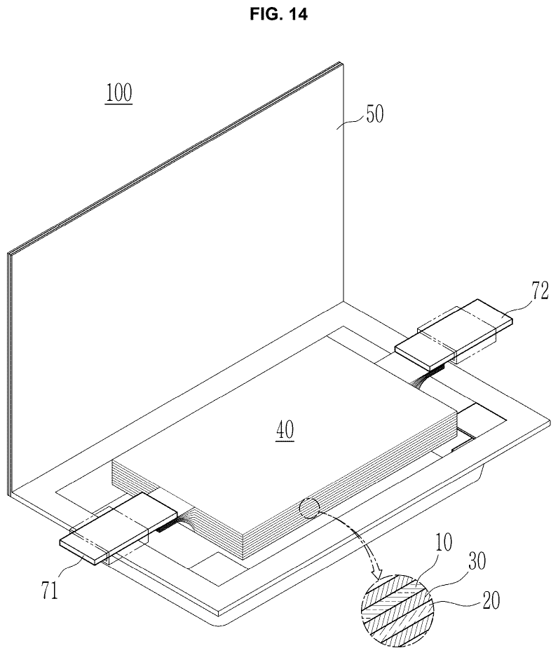

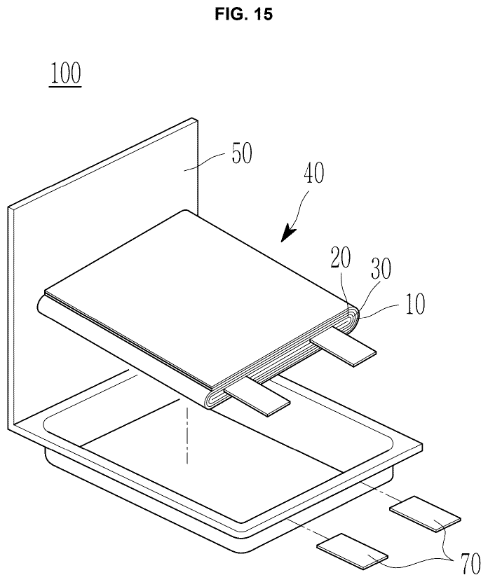

The rechargeable lithium battery may be classified into cylindrical, prismatic, pouch, coin, and/or the like, depending on the shape of the rechargeable lithium battery. FIGS. 12-15 are schematic diagrams showing the rechargeable lithium battery according to one or more embodiments, where FIG. 12 is a cylindrical battery, FIG. 13 is a prismatic battery, and FIGS. 14-15 are each a pouch-shaped battery. Referring to FIGS. 12-15, the rechargeable lithium battery 100 includes an electrode assembly 40 with a separator 30 between the positive electrode (cathode) 10 and the negative electrode (anode) 20, and a case 50 in which the electrode assembly 40 is housed. The positive electrode (cathode) 10, the negative electrode (anode) 20, and the separator 30 may be impregnated with an electrolyte. The rechargeable lithium battery 100 may include a sealing member 60 that seals the case 50 as shown in FIG. 12. In FIG. 13, the rechargeable lithium battery 100 may include a positive electrode (cathode) lead tab 11, a positive terminal 12, a negative electrode (anode) lead tab 21, and a negative terminal 22. As shown in FIGS. 14-15, the rechargeable lithium battery 100 includes electrode tabs 70, that may be a positive electrode (cathode) tab 71 and a negative electrode (anode) tab 72, that serves as an electrical path for inducing the current formed in the electrode assembly 40 to the outside.

The rechargeable lithium battery according to one or more embodiments may be rechargeable at a high voltage or may be suitable for being driven at a high voltage. For example, the upper charging limit voltage of a rechargeable lithium battery may be, at least, about 3.9 volt (V), or about 3.9 V to about 5 V, about 4 V to about 4.8 V, about 4.1 V to about 4.8 V, about 4.2 V to about 4.8 V, about 4.3 V to about 4.8 V, about 4.4 V to about 4.8 V, or about 4.5 V to about 4.7 V, and/or the like.

The battery may have a theoretical capacity of at least about 180 milliampere hour per gram (mAh/g), e.g., about 180 mAh/g to about 290 mAh/g, about 200 mAh/g to about 280 mAh/g, or about 220 mAh/g to about 270 mAh/g.

Use of the cathode active material in a high voltage battery may improve stability and cycle-life characteristics while maximizing or increasing charge capacity and energy density.

### Anode

The anode may include a current collector and an anode active material layer on the current collector, and the anode active material layer may include an anode active material, and may further include a binder, an electrically conductive material, and/or a (e.g., any suitable) combination thereof.

### Anode Active Material

The anode active material may include a material that reversibly intercalates/deintercalates lithium ions, a lithium metal, a lithium metal alloy, a material capable of doping/dedoping lithium, and/or transition metal oxide.

The material that reversibly intercalates/deintercalates lithium ions may include, for example, crystalline carbon, amorphous carbon, and/or a (e.g., any suitable) combination thereof as a carbon-based anode active material. The crystalline carbon may be irregular, or sheet, flake, spherical, or fiber shaped (e.g., in a form of fibers) and may be or include natural graphite and/or artificial graphite. The amorphous carbon may be a soft carbon, a hard carbon, a mesophase pitch carbonization product, calcined coke, and/or the like.

The lithium metal alloy includes an alloy of lithium and a metal selected from among Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based anode active material and/or a Sn-based anode active material. The Si-based anode active material may include silicon, a silicon-carbon composite, SiOx (0<x≤2), a Si-Q alloy (wherein Q is an element selected from among an alkali metal, an alkaline-earth metal, a Group 13 element, a Group 14 element (excluding Si), a Group 15 element, a Group 16 element, a transition metal, a rare earth element, and/or a (e.g., any suitable) combination thereof, for example, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and/or a (e.g., any suitable)combination thereof), and/or a (e.g., any suitable) combination thereof. The Sn-based anode active material may be Sn, SnO₂, SiOx (0<x<2), a Sn alloy, and/or a (e.g., any suitable) combination thereof.

The silicon-carbon composite may be a composite of silicon and amorphous carbon. An average particle diameter (D₅₀) of the silicon-carbon composite particles may be, for example, about 0.5 μm to about 20 μm. According to one or more embodiments, the silicon-carbon composite may be in the form of silicon particles and amorphous carbon coated on the surface of the silicon particles. For example, it may include a secondary particle (core) in which silicon primary particles are assembled and an amorphous carbon coating layer (shell) on the surface of the secondary particle. The amorphous carbon may also be present between the silicon primary particles, for example, the silicon primary particles may be coated with amorphous carbon. The secondary particles may exist dispersed in an amorphous carbon matrix.

The silicon-carbon composite may further include crystalline carbon. For example, the silicon-carbon composite may include a core including crystalline carbon and silicon particles and an amorphous carbon coating layer on the surface of the core. The crystalline carbon may be artificial graphite, natural graphite, and/or a (e.g., any suitable) combination thereof. The amorphous carbon may include soft carbon and/or hard carbon, a mesophase pitch carbonized product, and/or calcined coke.

If the silicon-carbon composite includes silicon and amorphous carbon, a content (e.g., amount) of silicon may be about 10 wt % to about 50 wt % and a content (e.g., amount) of amorphous carbon may be about 50 wt % to about 90 wt % based on 100 wt % of the silicon-carbon composite. In some embodiments, if the composite includes silicon, amorphous carbon, and crystalline carbon, a content (e.g., amount) of silicon may be about 10 wt % to about 50 wt %, a content (e.g., amount) of crystalline carbon may be about 10 wt % to about 70 wt %, and a content (e.g., amount) of amorphous carbon may be about 20 wt % to about 40 wt % based on 100 wt % of the silicon-carbon composite.

In embodiments, a thickness of the amorphous carbon coating layer may be about 5 nanometer (nm) to about 100 nm. An average particle diameter (D₅₀) of the silicon particles (primary particles) may be about 10 nm to about 1 μm, or about 10 nm to about 200 nm. The silicon particles may exist as silicon alone, in the form of a silicon alloy, and/or in an oxidized form. The oxidized form of silicon may be represented by SiOₓ (0<x≤2). At this time, the atomic content (e.g., amount) ratio of Si:O, which indicates a degree of oxidation, may be about 99:1 to about 33:67. As used herein, if (e.g., when) a definition is not otherwise provided, an average particle diameter (D₅₀) indicates a particle where an accumulated volume is about 50 volume % in a particle distribution.

The Si-based anode active material and/or Sn-based anode active material may be mixed with the carbon-based anode active material. If the Si-based anode active material and/or Sn-based anode active material and the carbon-based anode active material are mixed and used, the mixing ratio may be a weight ratio of about 1:99 to about 90:10.

### Binder

The binder serves to well adhere the anode active material particles to each other and also to adhere the anode active material to the current collector. The binder may be a non-aqueous binder, an aqueous binder, a dry binder, and/or a (e.g., any suitable) combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, and/or a (e.g., any suitable) combination thereof.

The aqueous binder may include a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and/or a (e.g., any suitable) combination thereof.

If an aqueous binder is used as the anode binder, a cellulose-based compound capable of imparting or increasing viscosity may be further included. As the cellulose-based compound, one or more of carboxymethyl cellulose, hydroxypropylmethyl cellulose, methyl cellulose, or alkali metal salts thereof may be mixed and used. The alkali metal may be Na, K, or Li.

The dry binder may be a polymer material capable of becoming fiberized, and may be, for example, polytetrafluoroethylene, polyvinylidene fluoride, a polyvinylidene fluoride-hexafluoropropylene copolymer, polyethylene oxide, and/or a (e.g., any suitable) combination thereof.

### Conductive Material

The conductive material is included to provide electrode conductivity (e.g., electrical conductivity) and any suitable electrically conductive material may be used as a conductive material unless it causes an undesirable chemical change in the rechargeable lithium battery. Examples of the conductive material include a carbon-based material such as natural graphite, artificial graphite, carbon black, acetylene black, ketjen black, a carbon fiber, a carbon nanofiber, a carbon nanotube, and/or the like; a metal-based material of a metal powder and/or a metal fiber including copper, nickel, aluminum silver, and/or the like; an electrically conductive polymer such as a polyphenylene derivative; and/or a (e.g., any suitable) mixture thereof.

A content (e.g., amount) of the anode active material may be about 95 wt % to about 99.5 wt % based on 100 wt % of the anode active material layer, and a content (e.g., amount) of the binder may be about 0.5 wt % to about 5 wt % based on 100 wt % of the anode active material layer. For example, the anode active material layer may include about 90 wt % to about 99 wt % of the anode active material, about 0.5 wt % to about 5 wt % of the binder, and about 0.5 wt % to about 5 wt % of the conductive material.

### Anode Current Collector

The anode current collector may include, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and/or an alloy thereof, and may be in the form of a foil, sheet, and/or foam. A thickness of the anode current collector may be, for example, about 1 μm to about 20 μm, about 5 μm to about 15 μm, or about 7 μm to about 10 μm.

### Electrolyte

In one or more embodiments, the electrolyte may be an electrolyte solution or a solid electrolyte. For example, the electrolyte may be an electrolyte solution for use in a rechargeable lithium battery and electrolyte solution may include a non-aqueous organic solvent and a lithium salt. In some embodiments, the electrolyte may be a solid electrolyte for use in a solid-state (e.g., all-solid) rechargeable lithium battery.

The non-aqueous organic solvent serves as a medium that transmits ions taking part in the electrochemical reaction of a battery. The non-aqueous organic solvent may be a carbonate-based, ester-based, ether-based, ketone-based, and/or alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, decanolide, mevalonolactone, valerolactone, caprolactone, and/or the like. The ether-based solvent may include dibutyl ether, tetraglyme, diglyme, dimethoxyethane, 2-methyltetrahydrofuran, 2,5-dimethyltetrahydrofuran, tetrahydrofuran, and/or the like. In some embodiments, the ketone-based solvent may include cyclohexanone, and/or the like. The alcohol-based solvent may include ethanol, isopropyl alcohol, and/or the like and the aprotic solvent may include nitriles such as R—CN (wherein R is a C2 to C20 linear, branched, or cyclic hydrocarbon group, a double bond, an aromatic ring, or an ether group, and/or the like); amides such as dimethylformamide; dioxolanes such as 1,3-dioxolane, 1,4-dioxolane, and/or the like; sulfolanes, and/or the like.

The non-aqueous organic solvent may be used alone or in a mixture of two or more types (kinds), and if two or more kinds are used in a mixture, a mixing ratio may be appropriately or suitably adjusted according to the desired or suitable battery performance.

If using a carbonate-based solvent, a cyclic carbonate and a chain carbonate may be mixed and used, and the cyclic carbonate and the chain carbonate may be mixed in a volume ratio of about 1:1 to about 1:9.

The non-aqueous organic solvent may further include an aromatic hydrocarbon-based organic solvent. For example, a carbonate-based solvent and an aromatic hydrocarbon-based organic solvent may be mixed and used in a volume ratio of about 1:1 to about 30:1.

The electrolyte solution may further include vinylethyl carbonate, vinylene carbonate, and/or an ethylene carbonate-based compound to improve battery cycle-life.

Examples of the ethylene carbonate-based compound may include fluoroethylene carbonate, difluoroethylene carbonate, chloroethylene carbonate, dichloroethylene carbonate, bromoethylene carbonate, dibromoethylene carbonate, nitroethylene carbonate, and cyanoethylene carbonate.

The lithium salt dissolved in the organic solvent supplies lithium ions in a battery, enables a basic operation of a rechargeable lithium battery, and improves transportation of the lithium ions between positive and anodes. Examples of the lithium salt may include at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl) imide; LiFSI), LiC₄F₉SO₃, LiN(CₓF₂ₓ₊₁SO₂)(C_{y}F_{2y=1}SO₂) (wherein x and y are integers of 1 to 20), lithium trifluoromethane sulfonate, lithium tetrafluoroethane sulfonate, lithium difluorobis(oxalato) phosphate (LiDFOB), and lithium bis(oxalato) borate (LiBOB).

A concentration of lithium salt may be within the range of about 0.1 M to about 2.0 M. If the concentration of lithium salt is within the described range, the electrolyte solution has appropriate or suitable ionic conductivity and viscosity, and thus excellent or suitable performance may be achieved and lithium ions may move effectively.

The solid electrolyte may include any material suitable for use as an ion conductive material, non-limiting examples of which include an inorganic solid electrolyte, a crystalline solid electrolyte, an amorphous solid electrolyte, or a combination thereof. The solid electrolyte may be, for example, a sulfide-based solid electrolyte, an oxide-based solid electrolyte, or a combination thereof. The sulfide-based solid electrolyte may include, for example, Li, S, and P and may optionally further include a halogen element. The sulfide-based solid electrolyte may be selected from sulfide-based solid electrolytes utilized in an electrolyte layer. For example, the sulfide-based solid electrolyte may have an ionic conductivity of at least about 1×10⁻⁵ siemens per centimeter (S/cm) at room temperature. The oxide-based solid electrolyte may include, for example, Li, O, and a transition metal element and may optionally further include other elements. For example, the oxide-based solid electrolyte may be a solid electrolyte having an ionic conductivity of at least about 1×10⁻⁵ S/cm at room temperature. The oxide-based solid electrolyte may be selected from oxide-based solid electrolytes suitable for use in an electrolyte layer.

### Separator

Depending on the kind of the rechargeable lithium battery, a separator may be present between the cathode and the anode. The separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and/or the like.

The separator may include a porous substrate and a coating layer including an organic material, an inorganic material, and/or a (e.g., any suitable) combination thereof on one or both surfaces (e.g., opposite surfaces) of the porous substrate.

The porous substrate may be a polymer film formed of any one polymer selected from among polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The porous substrate may have a thickness of about 1 μm to about 40 μm, for example, about 1 μm to about 30 μm, about 1 μm to about 20 μm, about 5 μm to about 15 μm, or about 10 μm to about 15 μm.

The organic material may include a (meth)acrylic copolymer including a first structural unit derived from (meth)acrylamide, and a second structural unit including at least one of a structural unit derived from (meth)acrylic acid or (meth)acrylate, and a structural unit derived from (meth)acrylamidosulfonic acid or a salt thereof.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and/or a (e.g., any suitable) combination thereof, but the present disclosure is not limited thereto. An average particle diameter (D₅₀) of the inorganic particles may be about 1 nm to about 2000 nm, for example, about 100 nm to about 1000 nm, or about 100 nm to about 700 nm.

The organic material and the inorganic material may be mixed in one coating layer, or a coating layer including an organic material and a coating layer including an inorganic material may be stacked.

The thickness of the coating layer may be about 0.5 μm to about 20 μm, for example, about 1 μm to about 10 μm, or about 1 μm to about 5 μm.

### Methods of Operating a Rechargeable Lithium Battery

One or more aspects of embodiments of the present disclosure are directed toward a method of operating a battery. For example, the battery may include a positive electrode that includes the doped, reconstructed nickel-rich cathode active material described herein; a negative electrode; and an electrolyte between the positive electrode and the negative electrode. In one or more embodiments, a capacity retention of the battery may be at least about 85% if (e.g., when) an operating voltage is at least about 3.9 volt (V). For example, the battery may be a rechargeable lithium battery or a solid-state battery.

In one or more embodiments, an amount of oxygen released from the battery during operating the battery may be at least about 50% less than an amount of oxygen released during operating a comparable battery including a cathode active material that excludes the reconstructed region of the present disclosure. For example, the amount of oxygen released may be about 50% to about 99%, about 50% to about 95%, about 50% to about 90%, about 50% to about 80%, about 50% to about 70%, about 50% to about 60%, about 60% to about 95%, about 60% to about 90%, about 60% to about 80%, about 60% to about 70%, about 70% to about 95%, about 70% to about 90%, about 70% to about 85%, about 70% to about 80%, about 80% to about 95%, about 80% to about 90%, about 85% to about 95%, or about 85% to about 90% less than the amount of oxygen released during operating the comparable battery as described herein. For example, the amount of oxygen as described herein may be released from the battery, the cathode active material thereof, and/or the nickel composite oxide thereof, and may be released during charging the battery and/or during discharging the battery.

The methods may include charging the battery to an upper limit voltage of at least about 3 V. For example, the upper limit voltage may be about 3 V to about 4.5 V, about 3 V to about 3.9 V, about 3.1 V to about 3.8 V, about 3.2 V to about 3.7 V, or about 3.3 V to about 3.6 V. The method may include the act or task of operating the battery between about 3 V and about 4.8 V, e.g., about 3 V to about 4.7 V, about 3 V to about 4.5 V, about 3.2 V to about 4.8 V, about 3.5 V to about 4.8 V, about 4 V to about 4.8 V, about 4.3 V to about 4.8 V, about 4.4 V to about 4.8 V, or about 4.5 V to about 4.7 V.

The methods may include the act or task of operating the battery at a rate of about 0.2 coulomb (C) to about 10 C, e.g., about 0.5 C to about 10 C, about 1 C to about 8 C, about 1 C to about 7 C, about 1 C to about 6 C, about 1 C to about 5 C, about 1 C to about 4 C, about 1 C to about 3 C, about 1 C to about 2 C, about 2 C to about 8 C, about 2 C to about 6 C, about 2 C to about 5 C, about 2 C to about 4 C, about 2 C to about 3 C, about 3 C to about 8 C, about 3 C to about 7 C, about 3 C to about 6 C, about 3 C to about 5 C, or about 3 C to about 4 C.

The methods may include the act or task of operating the battery for at least about 50 charge-discharge cycles. For example, a total number of charge-discharge cycles of operating the battery may be about 50 to about 1000, about 50 to about 800, about 50 to about 700, about 50 to about 500, about 50 to about 400, about 50 to about 300, about 50 to about 200, about 50 to about 100, about 100 to about 500, about 100 to about 400, about 100 to about 300, about 100 to about 200, about 150 to about 500, about 150 to about 400, about 150 to about 300, about 150 to about 200, about 200 to about 500, about 200 to about 400, about 200 to about 300, or about 100 to about 200.

The methods of operating the battery may include achieving or realizing a capacity retention of at least about 60%. The term “capacity retention” as used herein refers a charge capacity of the battery after being operated at a voltage range, a rate of coulombic range, and a total number of charge-discharge cycles as described herein. The capacity retention may be a percentage of the battery's initial charge capacity before being operated. For example, operating the battery may obtain, achieve or realize a capacity retention of about 65% to about 99%, about 70% to about 95%, about 70% to about 90%, about 70% to about 85%, about 70% to about 80%, about 70% to about 75%, about 75% to about 95%, about 75% to about 90%, about 75% to about 85%, about 75% to about 80%, about 80% to about 95%, about 80% to about 90%, about 80% to about 85%, about 85% to about 95%, or about 85% to about 90%.

Hereinafter, the doped, reconstructed nickel-rich cathode active material according to one or more embodiments of the present disclosure will be further explained referring to one or more examples. The examples are only illustrations to assist the understanding of the subject matter of the present disclosure, and the scope of the present disclosure is not limited thereto.

### EXAMPLES

### Preparation of a Nickel-Rich Cathode Active Material Bulk Composition

A bulk composition of the nickel-rich cathode active material LiNi_{0.97}Co_{0.02}Al_{0.01}O₂ (NCA97) was formed by mixing stoichiometric amounts of precursors LiOH and Al(NO₃)₃·9 H₂O. The precursors were dispersed in a solution of de-ionized water and mixed by a blade mixer at 80° C. for 30 mins. A 6 mol %-excess of LiOH was added, e.g., to compensate for possible of Li loss during firing. A stoichiometric amount of LiNi_{0.98}Co_{0.02}O was added slowly to the solution at 130° C. over a period of 2 h. The LiNi_{0.98}Co_{0.02}O is commercially unavailable and was produced by Samsung SDI Co., LTD. The solution was then air-dried in an oven at 90° C. overnight. After drying, the mixture was manually ground to obtain the bulk composition as a fine powder.

### Preparation of Doping Reconstruction Compositions

To synthesize the Li_{1.2}Ni_{0.33}Ti_{0.33}Mo_{0.13}O₂ doping reconstruction (DRX) composition (LNTM), the precursors Li₂CO₃, NiO, TiO₂, and MoO₂ were used. To synthesize the Li_{1.2}Ni_{0.33}Ti_{0.33}W_{0.13}O₂ doping reconstruction (DRX) composition (LNTW), the precursors Li₂CO₃, NiO, TiO₂, and WO₃ were used. In a stoichiometric ratio, the preceding precursors were dispersed into acetone and ball-milled by zirconia grinding media in a polypropylene jar for 18 hours and dried overnight in an oven at 90° C. After drying, each mixture was manually ground to obtain the doping reconstruction (DRX) compositions as fine powders.

### Synthesis of Doped, Reconstructed Nickel-Rich Cathode Active Materials

The bulk composition NCA97 powder and one of the doping reconstruction (DRX) composition powders were mixed manually in a weight ratio of 1:0.02 to provide an intermediate that was calcined in a tube furnace for 15 h at 750° C. under flowing oxygen atmosphere to provide the doped, reconstructed nickel-rich cathode active materials LNTM-NCA97 or LNTW-NCA97.

Evaluation with X-Ray Powder Diffraction, Scanning Electron Microscopy (SEM), and Energy-Dispersive X-Ray Spectroscopy (EDS)

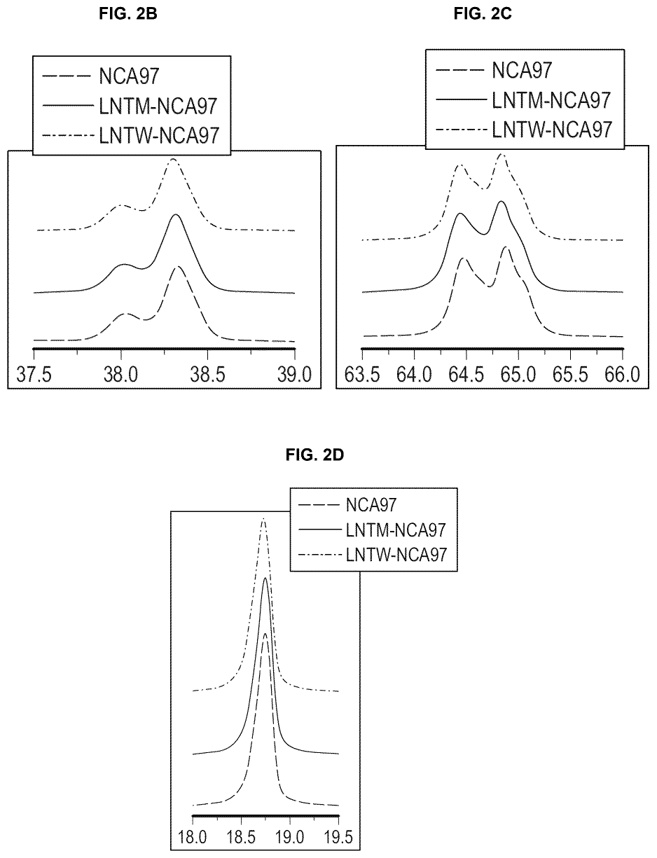

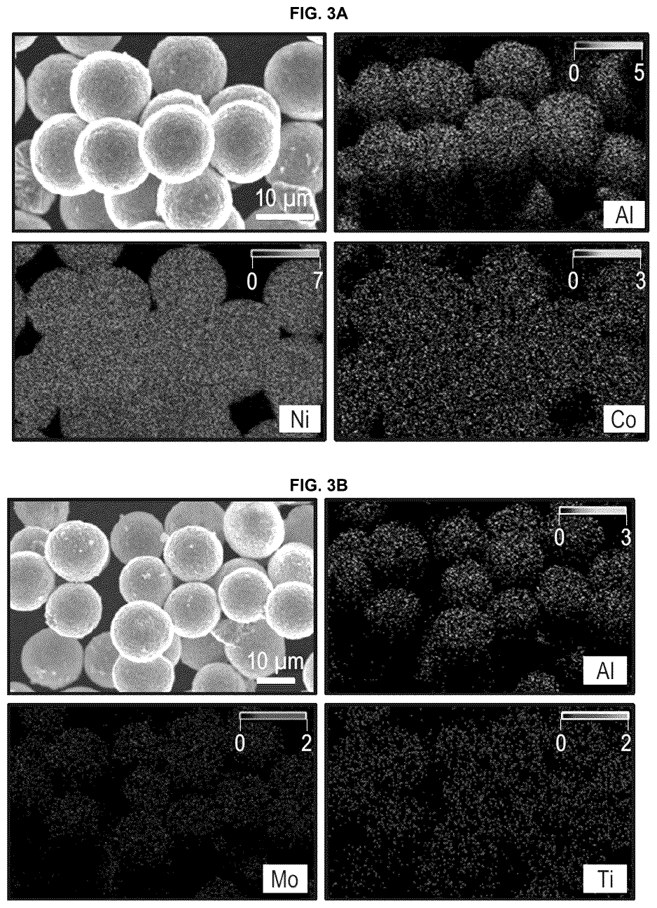

FIG. 2A shows the X-ray powder diffraction (XRD) patterns of the nickel-rich cathode active material NCA97 as prepared without DRX incorporation and the doped, reconstructed cathode active materials LNTM-NCA97 and LNTW-NCA97. All three samples have a well-defined rhombohedral structure, which can be indexed to α-NaFeO₂ hexagonal structure corresponding to the R-3m space group. Note that several small, unassigned peaks are attributed to the diffractometer and are not associated with the samples. After DRX addition, no extra impurity diffraction peaks were produced, indicating that the DRX addition does not change the crystal structure of NCA97. Because there were no DRX peaks observed, we consider the relative amount of the DRX composition was too small to be observed by XRD. FIGS. 2B and 2C show the peak splitting for (006)/(012) plane and the (018)/(110) plane, respectively, which were clearly observed for both NCA97, the LNTM-NCA97, and the LNTW-NCA97, suggesting the structure of each product was substantially layered. FIG. 2D shows that for the (003)/(104) plane, peak intensity ratios were 1.14 for NCA97, 1.16 for LNTM-NCA97, and 1.21 for LNTW-NCA97, all of which demonstrates the structure of each product was substantially layered to provide high Li activation.

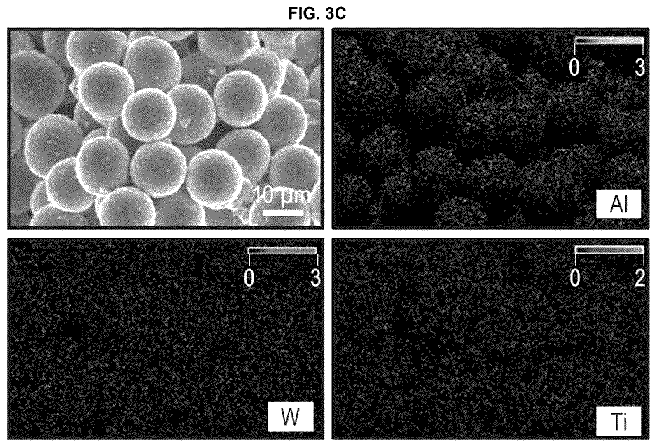

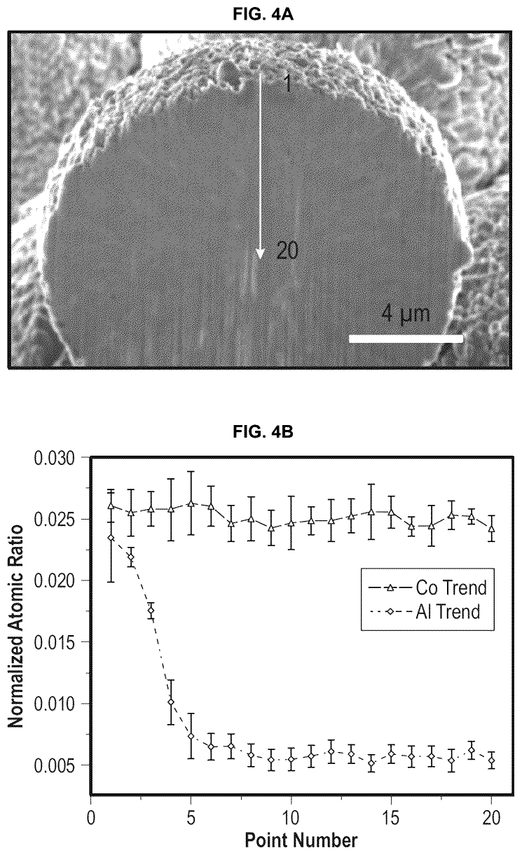

Elemental distribution on the surface and across the particle cross-section of the NCA97, LNTM-NCA97, and LNTW-NCA97 prepared as described herein were evaluated using scanning electron microscopy (SEM) with energy-dispersive X-ray spectroscopy (EDS) and focused ion beam etching. FIG. 3A (upper left) shows an SEM image of NCA97 indicating spherical particles having an average diameter about 14 micrometer (μm). The spherical particles are secondary particles formed by the agglomeration of primary particles having an average diameter of about 300 nanometer (nm). Results of EDS mapping indicates the surface of the NCA97 has a uniform distribution of Al (upper right, FIG. 3A), Ni (lower left, FIG. 3A), and Co (lower right, FIG. 3A).

FIGS. 3B and 3C (upper left) show SEM images of LNTM-NCA97 and LNTW-NCA97, respectively, indicating spherical particles having substantially the same dimensions as the NCA97 spherical particles of FIG. 3A (upper left), e.g., secondary particles having of an average diameter about 14 μm being an agglomeration of primary particles having an average diameter of about 300 nm. Results of EDS mapping indicate that addition of the DRX precursor mixtures resulted in changes to the surface composition of LNTM-NCA97 and LNTW-NCA97, respectively, for Al (upper right, FIGS. 3B-3C), Mo (lower left, FIG. 3B), Wi (lower left, FIG. 3C), and Ti (lower right, FIGS. 3B-3C). LNTM-NCA97 and LNTW-NCA97 show uniform distribution of Ti—Mo and Ti—W, respectively.

### Evaluation of Cross-Sectional SEM Images and EDS Intensities

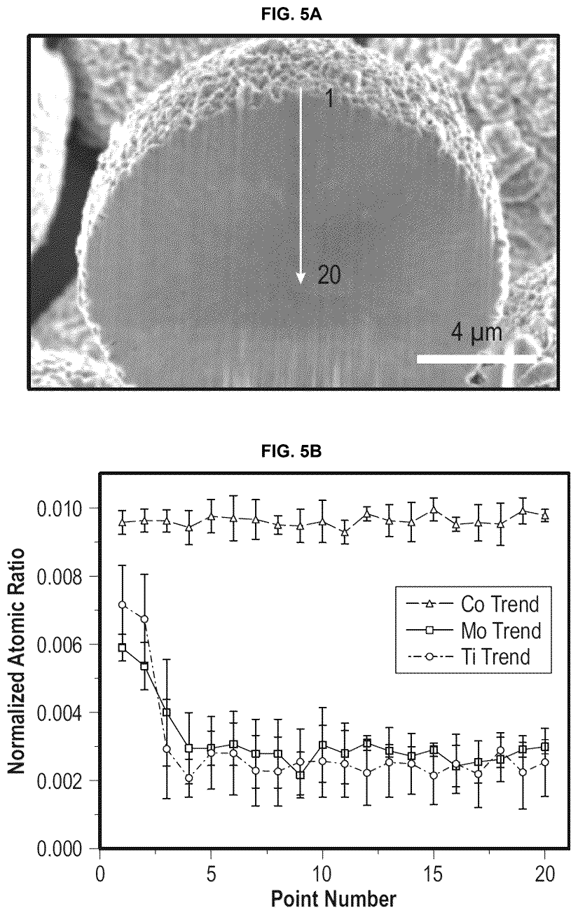

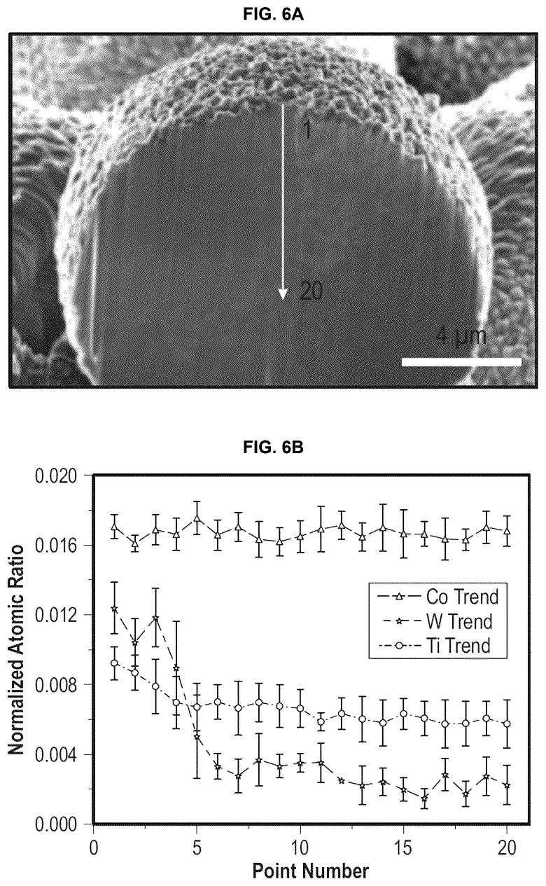

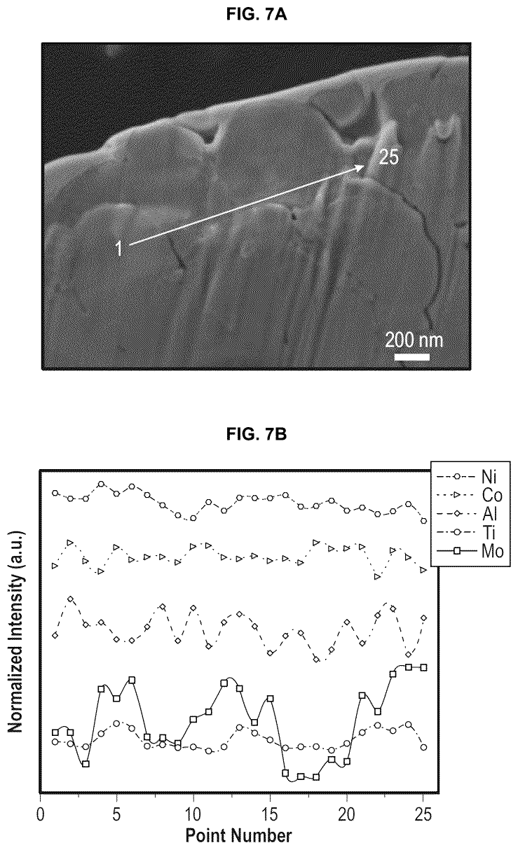

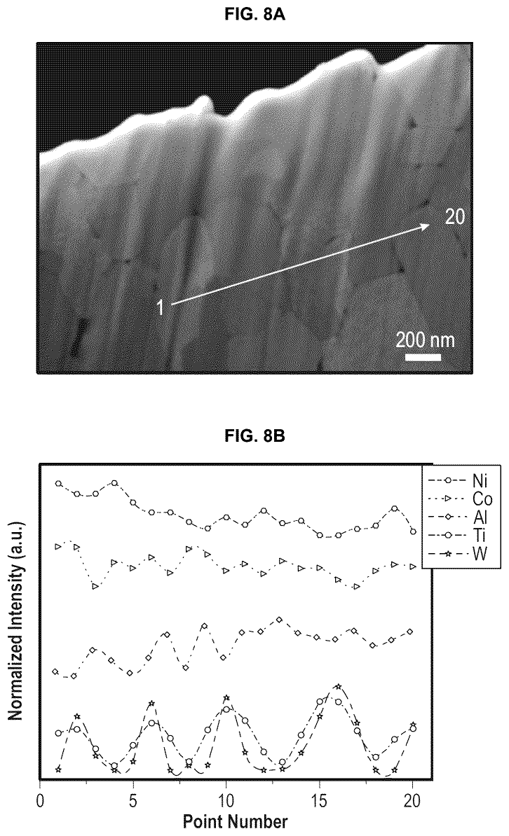

FIG. 4A shows a cross-sectional SEM image of an NCA97 particle and FIG. 4B shows a set of normalized EDS intensities obtained from a line scan of the NCA97 particle, with error bars indicating the results obtained over a series of five repeated trials. The results of the line scans indicate that the concentration of Al tends to be greater in a surface region of the secondary particle, and a thickness of the concentrated Al layer is around 1 μm. In contrast, the Co intensity is relatively uniform throughout the particle. FIG. 5A shows a cross-sectional SEM image of an LNTM-NCA97 particle and FIG. 5B shows a set of normalized EDS intensities obtained from a line scan of the LNTM-NCA97 particle, with error bars indicating the results obtained over a series of five repeated trials. FIG. 6A shows a cross-sectional SEM image of an LNTW-NCA97 particle and FIG. 6B shows a set of normalized EDS intensities obtained from a line scan of the LNTW-NCA97 particle, with error bars indicating the results obtained over a series of five repeated trials. The results indicate that the concentration of DRX-unique elements, such as Ti and Mo for LNTM and Ti and W for LNTW is greater in a surface region of the particles.

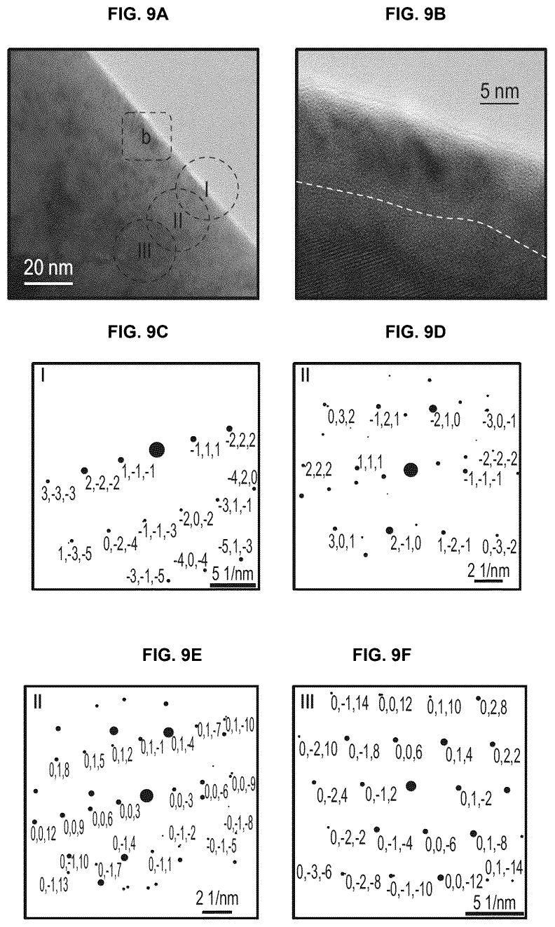

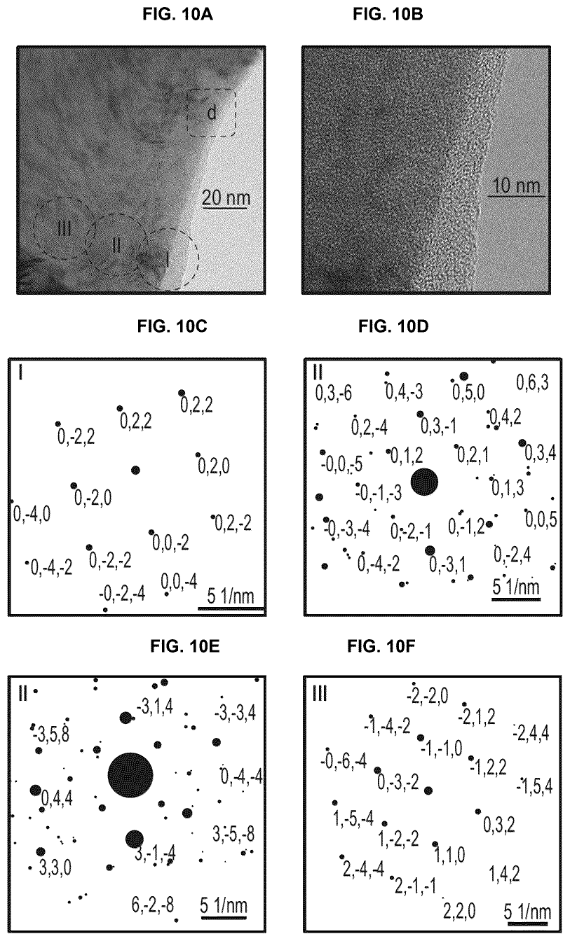

FIGS. 7A and 8A show a cross-sectional SEM image of an LNTM-NCA97 primary particle and an LNTW-NCA97 primary particle, respectively, near the surface of the secondary particle. FIGS. 7B and 8B show a set of normalized EDS intensities obtained from a line scan across the LNTM-NCA97 primary particle and the LNTW-NCA97 primary particle, respectively. The results indicate that for both particles, the distribution of Ni, Co, and Al across the primary particles is consistent (e.g., remains similar). In contrast, Ti and Mo for LNTM-NCA97 and Ti and W for LNTW-NCA97 show fluctuation that coincides with a position of the EDS point. The results indicate that the concentration of DRX-unique elements, such as Ti and Mo for LNTM and Ti and W for LNTW is greater in near a surface region of the primary particles.

Evaluation with High Resolution Transmission Electron Microscopy

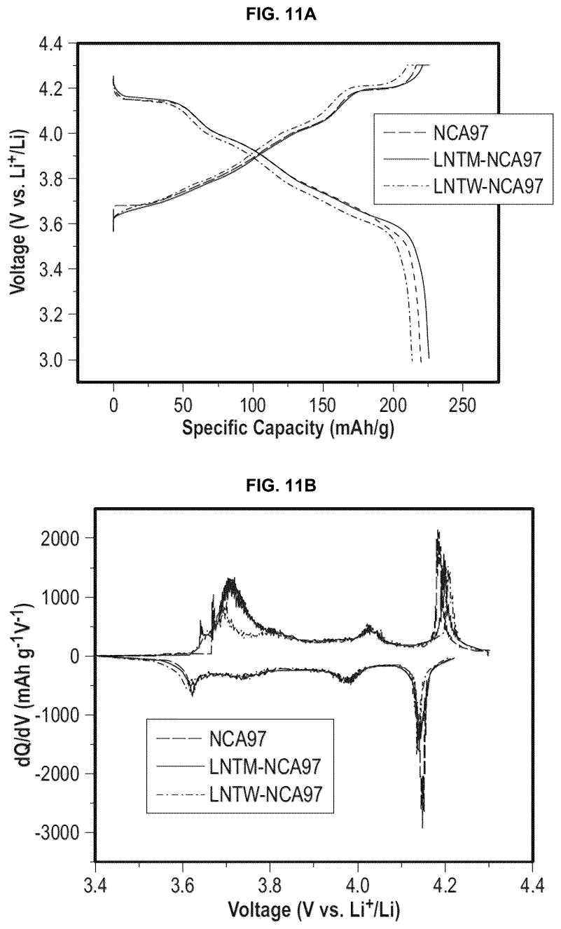

FIGS. 9A and 9B are high resolution transmission electron microscopy (TEM) images for the LNTM-NCA97 particle that confirm the crystal structure of the surface phases observed in the SEM images discussed herein. The surface of the particle has distinctive lattice fringes with different interplanar distance from the bulk, as indicated by the dashed line. The bulk site of the LNTM-NCA97 particle has a well-ordered structure with interplanar spacing of 0.475 nm, conforming to the (003) plane adjacent to the (101) plane of the R-3m layered structure. The surface site, in contrast, has a different interplanar distance of 0.24 nm, which may be related to a (111) plane of the Fm-3m space group from the DRX structure. FIGS. 9C, 9D, 9E and 9F are selected area electron diffraction (SAED) images of the LNTM-NCA97 particle that were performed to further investigate the surface phase. By moving the selected area aperture from area I to II and from area II to III, three different patterns were observed. First, the corresponding SAED pattern in area I can be indexed as [1,2,−1] projection from the Fm-3m structure, revealing that these particles are DRX with a cubic symmetry. The SAED pattern in area II includes a [1,2,−3] projection from DRX and a [1,0,0] projection of the R-3m structure. In area III, the pattern indicates strong [1,0,0] projection of the layered structure. This is clear and solid evidence that the DRX phase is present in the surface of the layered structure of the LNTM-NCA97 particle.

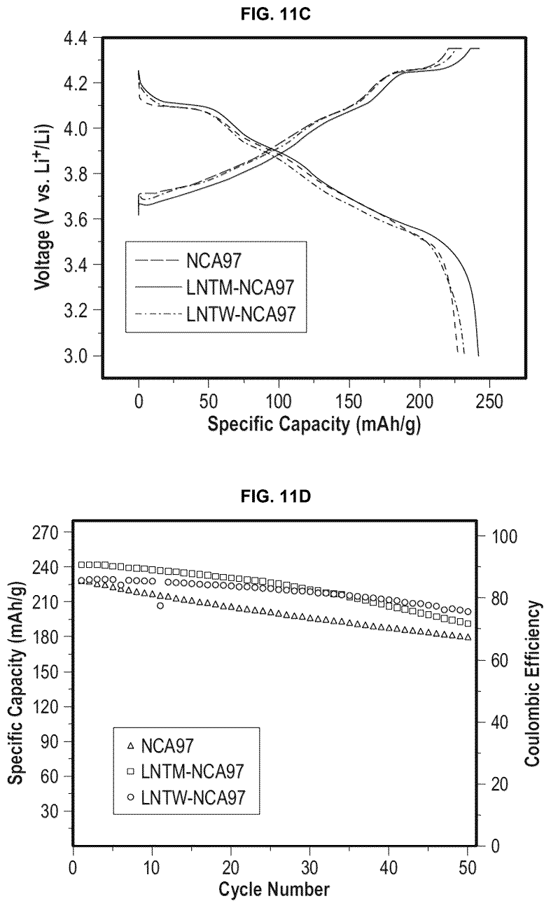

FIGS. 10A and 10B are high resolution transmission electron microscopy (TEM) images for the LNTW-NCA97 particle that confirm the crystal structure of the surface phases observed in the SEM images discussed herein. FIGS. 10C, 10D, 10E and 10F are selected area electron diffraction (SAED) images of the LNTW-NCA97 particle that were performed to further investigate the surface phase. The results indicate that the morphology of the LNTW-NCA97 particle is substantially the same as the morphology of the LNTM-NCA97 particle discussed in the preceding section. For example, the surface Fm-3m phase separated from the layered R-3m structure is observed.

### Evaluation of Cell Performance

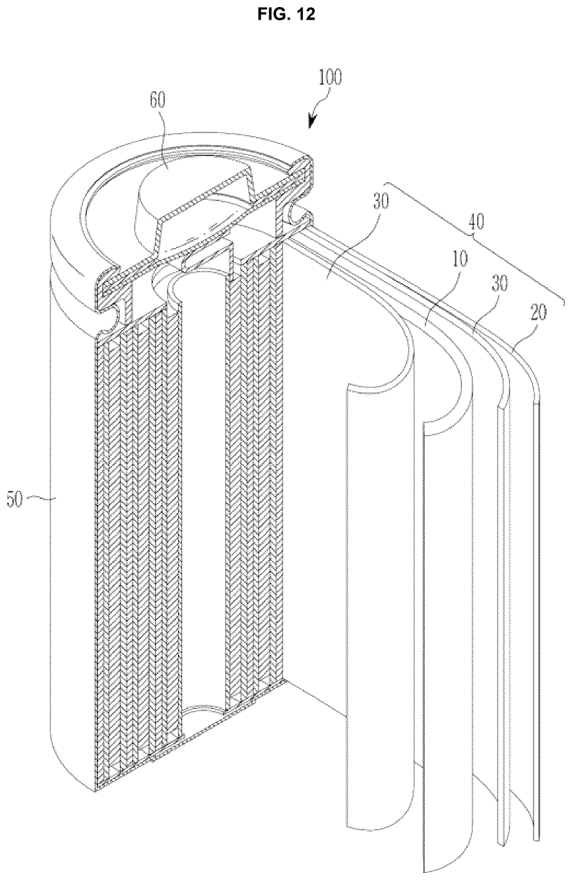

Electrochemical cell performance was evaluated by preparing CR2032 coin cells using a lithium metal as counter electrode and one of the NCA97 cathode, the LNTM-NCA97 cathode, or the LNTW-NCA97 cathode. FIG. 11A shows the charge-discharge profiles of the second cycle for the three different cathodes at a current density of 0.2 C (1 C: 270 milliampere per gram (mAh/g), voltage window: 3.0-4.3 V) and room temperature. NCA97, LNTM-NCA97, and LNTW-NCA97 displayed similar discharge capacities of 221 mAh/g, 226 mAh/g, and 216 mAh/g, respectively.

FIG. 11B shows the results of differential capacity as a function of voltage (dQ/dV) curve, and may be used to evaluate redox kinetics and phase transitions. The peaks are indicative of the first-order phase transitions associated with the abrupt contraction/expansion of the lattice parameters and/or Li/vacancy ordering upon charge and discharge. FIG. 11B shows that each of the three cathodes experienced similar phase transitions upon delithiation from the initial hexagonal phase (H1) to the monoclinic phase (M) and two other hexagonal phases (H2 and H3). The H2-H3 phase transition is known to be responsible for the capacity fading of Ni-rich cathode materials. The H2-H3 redox peaks for the LNTM-NCA97 cathode and the LNTW-NCA97 cathode were observed to have smaller peak intensities and higher voltages when compared to the NCA97 cathode upon charging, suggesting that the unfavorable H2-H3 phase transition can be pushed to higher voltage. This observation agrees well with the improved capacity retention because the suppressed H2-H3 phase transition would mitigate the structural instability.

FIG. 11C shows the results of second charge-discharge curves at 1 C between 3 V and 4.35 V and that initial capacities of the NCA97 cathode, the LNTM-NCA97 cathode, and the LNTW-NCA97 cathode were 229 mAh/g, 241 mAh/g, and 231 mAh/g, respectively. FIG. 11D shows the capacity variation of the three cathodes as a cycle number at 1 C, after 50 cycles. Use of the NCA97 cathode resulted in the largest capacity decay, e.g., 78% retention rate after 50 cycles. Use of the LNTM-NCA97 cathode resulted in 79% capacity retention rate after 50 cycles due to rapid fading after 30 cycles, which may be due to the faster electrolyte decompositions caused by higher capacity than NCA97 at 45° C. Use of the LNTWM-NCA97 cathode resulted in suitable or excellent cyclability of 89% retention after 50 cycles.

According to one or more embodiments of the present disclosure, electrochemical properties of a nickel-rich cathode active material may be enhanced or improved when it is prepared using a doping reconstruction (DRX) precursor mixture. For example, use of the DRX precursor mixture may provide a doped, reconstructed nickel-rich cathode active material having a doped, reconstructed surface that is passivated. In one or more embodiments, the doped, reconstructed surface may provide a protective layer that reduces or prevents degradation of the surface of the bulk nickel-rich cathode active material and/or the doped, reconstructed nickel-rich cathode active material.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

A battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the components of the device may be formed on one integrated circuit (IC) chip or on separate IC chips. Further, the components of the device may be implemented on a flexible printed circuit film, a tape carrier package (TCP), a printed circuit board (PCB), or formed on one substrate. Further, the components of the device may be a process or thread, running on one or more processors, in one or more computing devices, executing computer program instructions and interacting with other system components for performing the functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of computing devices may be combined or integrated into a single computing device, or the functionality of a particular computing device may be distributed across one or more other computing devices without departing from the scope of the present disclosure.

Example embodiments of the present disclosure have been described, but the present disclosure is not limited thereto. One or more suitable other modifications may be implemented within the scope of the claims, the detailed description of the present disclosure, and the appended drawings, and are also included in the scope of the present disclosure. Accordingly, any modified embodiments may not be understood separately from the technical ideas and aspects of the present disclosure, and the modified embodiments are within the scope of the appended claims and equivalents thereof.

Reference Numerals

| | |
|---|---|
| 100: rechargeable lithium battery | 10: positive electrode |
| 11: positive electrode lead tab | 12: positive terminal |
| 20: negative electrode | 21: negative electrode lead tab |
| 22: negative terminal | 30: separator |
| 40: electrode assembly | 50: case |
| 60: sealing member | 70: electrode tab |
| 71: positive electrode tab | 72: negative electrode tab |

What is claimed is:

1. A cathode active material comprising:
an amount of nickel of at least about 85 mol % based on a total weight of the cathode active material;
a bulk region; and
a reconstructed region;
the bulk region having a bulk crystal structure having a bulk space group and a bulk interplanar spacing, the reconstructed region having a surface crystal structure having a surface space group and a surface interplanar spacing, wherein,
the bulk space group is different than the surface space group,
the bulk interplanar spacing is greater than the surface interplanar spacing, and
the cathode active material is a doped, reconstructed nickel-rich cathode active material.

2. The cathode active material as claimed in claim 1, wherein:
the bulk crystal structure has a layered structure, and
the bulk interplanar spacing is about 0.45 nanometer (nm) to about 0.50 nm.

3. The cathode active material as claimed in claim 1, wherein the bulk space group is a rhombohedral space group having a (003) plane and a (101) plane adjacent to the (003) plane.

4. The cathode active material as claimed in claim 1, wherein the surface interplanar spacing is about 0.20 nm to about 0.30 nm.

5. The cathode active material as claimed in claim 1, wherein the surface space group is a face centered cubic space group having a (111) plane.

6. The cathode active material as claimed in claim 1, wherein the bulk interplanar spacing is about 1.8 to about 2.2 times greater than the surface interplanar spacing.

7. The cathode active material as claimed in claim 1, wherein the bulk crystal structure has a [1, 0, 0] projection and a layered symmetry.

8. The cathode active material as claimed in claim 1, wherein the surface crystal structure has a [1, 2, −1] projection and a cubic symmetry.

9. The cathode active material as claimed in claim 1, further comprising a group 4 element, a group 6 element, a group 13 element, and at least one element selected from among groups 8 to 10, as selected from the Periodic Table of Elements.

10. The cathode active material as claimed in claim 1, further comprising a bulk composition represented by Chemical Formula 1 and a doping composition represented by Chemical Formula 2: 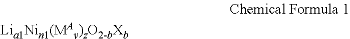
wherein, each M^{A} is independently selected from among Al, B, Ba, Ca, Ce, Co, Cr, Cu, Fe, Mg, Mn, Mo, Nb, Si, Sn, Sr, Ti, V, W, and Zr,
each X is independently selected from among F, P, and S,
0.9≤a1≤1.2,
0.8≤n1≤0.995,
each y is independently a real number from 0 to 0.2,
z is an integer from 1 to 5, and
0≤b≤0.1, 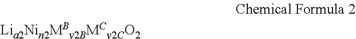
wherein,
M^{B} is a transition metal selected from a group 4 element,
M^{C} is a transition metal selected from a group 6 element,
0.9≤a2≤1.5,
n2 and y2B are each independently a real number from 0.27 to 0.39, and
a sum of n2+y2B+y2C is equal to 2−a2.

11. The cathode active material as claimed in claim 10, wherein:
the bulk composition is represented by Chemical Formula 1A and the doping composition is represented by Chemical Formula 2A: 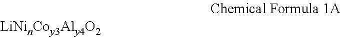
wherein,
0.9≤n≤0.995,
0.005≤y3≤0.1, and
a sum of n+y3+y4 is equal to 1, 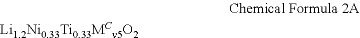
wherein,
M^{C} is Mo or W and
0.10≤y5≤0.16.

12. The cathode active material as claimed in claim 1, wherein the reconstructed region is at a surface of the cathode active material and comprises a group 4 element and a group 6 element.

13. The cathode active material as claimed in claim 12, wherein the reconstructed region further comprises a group 13 element and at least one element selected from among groups 8 to 10.

14. The cathode active material as claimed in claim 12, wherein a thickness of the reconstructed region is about 2% to about 20% of a size of primary particles of the cathode active material.

15. The cathode active material as claimed in claim 1, further comprising secondary particles, each secondary particle comprising an agglomeration of primary particles,
wherein:
each secondary particle has an average particle diameter (D50) of about 10 micrometer (μm) to about 18 μm, and
the primary particles have an average particle diameter (D50) of about 15 nanometer (nm) to about 300 nm.

16. A method comprising:
providing a bulk composition;
providing a doping composition;
mixing the bulk composition and the doping composition to provide an intermediate; and
heat treating the intermediate in an oxidative atmosphere,
wherein the method is a method of manufacturing a doped, reconstructed nickel-rich cathode active material and the method comprises a single heat treating.

17. The method as claimed in claim 16, wherein the providing the intermediate comprises mixing the bulk composition and the doping composition in a weight ratio of about 1:0.5 to about 1:0.001.

18. The method as claimed in claim 16, wherein:
the providing the bulk composition comprises:
mixing an amount of a first Li compound, an amount of an Al salt, and a first solvent to form a first precursor;
providing to the first precursor an added portion of the first Li compound and an amount of a Ni composite oxide to form a first composite, the Ni composite oxide represented by Chemical Formula 3; 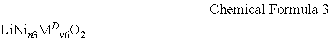
wherein, M^{D} is Co or Fe, 0.9≤n3≤0.995, and a sum of n3+y6 is equal to 1; and
heat treating the first composite, and wherein
the providing the doping composition comprises:
mixing an amount of a second Li compound, an amount of an Ni oxide, an amount of a group 4 oxide, an amount of a group 6 oxide, and a second solvent to form a second precursor;
processing the second precursor; and
heat treating the second precursor.

19. The method as claimed in claim 18, wherein the group 4 oxide is TiO₂ and the group 6 oxide is MoO₂ or WO₃.

20. A method of operating a battery, the battery comprising:
a positive electrode comprising the cathode active material of claim 1;
a negative electrode; and
an electrolyte between the positive electrode and the negative electrode,
wherein a capacity retention of the battery is at least about 85% if an operating voltage is at least about 3.9 volt (V).
